(19) United States
(12) Patent Application Publication
(10) Pub. No.: US 2026/0063867 A1
(43) Pub. Date: Mar. 5, 2026

(54) ACTUATOR FOR OPTICAL AXIS ADJUSTMENT AND OPTICAL AXIS ADJUSTMENT DEVICE

(71) Applicant: Tamron Co., Ltd., Saitama (JP)

(72) Inventors: Yoshinori UENO, Saitama (JP); Masamitsu HYODO, Saitama (JP); Lingjian MENG, Saitama (JP)

(73) Assignee: Tamron Co., Ltd., Saitama (JP)

(21) Appl. No.: 19/256,158

(22) Filed: Jul. 1, 2025

(30) Foreign Application Priority Data
Aug. 28, 2024 (JP) 2024-146740

(51) Int. Cl. G02B 7/18; H02K 11/215; H02K 41/035

(52) U.S. Cl. CPC G02B 7/1805; H02K 11/215; H02K 41/0358

(57) ABSTRACT

An actuator for optical axis adjustment, which allows a wedge prism to be mounted thereon and is rotationally driven by a voice coil motor, has a bearing structure in which rolling members are sandwiched between a groove on a movable unit and a groove on a fixed unit that face mutually radially.

### CROSS-REFERENCE TO RELATED APPLICATIONS

This application is based on and claims the benefit of priority from Japanese Patent Application No. 2024-146740, filed on Aug. 28, 2024, the entire contents of which are incorporated herein by reference.

### BACKGROUND OF THE INVENTION

### Technical Field

The present invention relates to an actuator for optical axis adjustment and an optical axis adjustment device.

### Related Art

Known has been an optical axis adjustment device that moves an anisotropic optical element, such as a wedge prism, rotationally around the optical axis of the optical element by electromagnetic force. As a constituent for achieving such an optical axis adjustment device, known has been an actuator for moving a wedge prism rotationally by electromagnetic force. The actuator includes a fixed unit and a movable unit for holding the wedge prism. The fixed unit and the movable unit have, on their mutually facing main faces, respective grooves extending along the rotational direction of the movable unit. Then, the respective grooves of the fixed unit and the movable unit face mutually in the axial direction of rotational motion of the movable unit, and rolling elements are sandwiched therebetween. Due to such a configuration of the actuator, the driving direction of rotation of the movable unit is regulated (e.g., refer to JP 2012-137734 A).

On the other hand, for an optical axis adjustment device for use in optical wireless communication, the above-described actuator is required to rotate the wedge prism at a high rate. Regarding a conventional actuator having a structure in which rolling members are sandwiched axially between grooves, in a high-rate range in which a large thrust is generated, the pose of a movable unit deviates from its initial pose at the time of rotation due to the precision of assembly or components or due to backlash between the rolling members and the grooves, resulting in play of the optical axis of a wedge prism.

An object of an aspect of the present invention is to achieve an optical axis adjustment device that inhibits play of the optical axis of an anisotropic optical element even at the time of high-rate rotation, and an actuator therefor.

### SUMMARY OF THE INVENTION

In order to solve the above-described problem, according to an aspect of the present invention, provided is an actuator for optical axis adjustment including: a fixed unit; a movable unit configured to hold an anisotropic optical element, the movable unit being attached rotatably to the fixed unit; a magnetic-field generator for driving disposed along a rotational direction of the movable unit in one of the movable unit and the fixed unit; a coil disposed along the rotational direction in another of the movable unit and the fixed unit, the coil overlapping the magnetic-field generator for driving; a first groove formed circumferentially on the movable unit with respect to the rotational direction; a second groove formed circumferentially on the fixed unit with respect to the rotational direction; and three or more rolling members sandwiched between the first groove and the second groove, in which the first groove and the second groove face mutually radially with respect to the rotational direction.

In addition, in order to solve the above-described problem, according to an aspect of the present invention, provided is an optical axis adjustment device including: the actuator for optical axis adjustment described above; and an anisotropic optical element held by the movable unit.

According to an aspect of the present invention, achieved can be an optical axis adjustment device that inhibits play of the optical axis of an anisotropic optical element even at the time of high-rate rotation, and an actuator therefor.

### BRIEF DESCRIPTION OF THE DRAWINGS

FIG. 1 is a plan view schematically illustrating an actuator for optical axis adjustment according to a first embodiment of the present invention;

FIG. 2 is a sectional view schematically illustrating a longitudinal section of the actuator for optical axis adjustment according to the first embodiment of the present invention;

FIG. 3 is a sectional view schematically illustrating a cross section of the actuator for optical axis adjustment according to the first embodiment of the present invention;

FIG. 4 is an exploded perspective view schematically illustrating the configuration of the actuator for optical axis adjustment according to the first embodiment of the present invention;

FIG. 5 is a schematic view of a first example of arrangement of magnets for driving and coils in the actuator for optical axis adjustment according to the first embodiment of the present invention;

FIG. 6 is a schematic view of a second example of arrangement of magnets for driving and coils in the actuator for optical axis adjustment according to the first embodiment of the present invention;

FIG. 7 is a schematic view of an example of arrangement of a magnet for driving in an actuator for optical axis adjustment according to a second embodiment of the present invention;

FIG. 8 is a schematic view of an example of arrangement of coils in the actuator for optical axis adjustment according to the second embodiment of the present invention;

FIG. 9 is a front view schematically illustrating an example of arrangement of a magnet for driving and coils in an actuator for optical axis adjustment according to a third embodiment of the present invention;

FIG. 10 is a side view schematically illustrating the example of arrangement of a magnet for driving and coils in the actuator for optical axis adjustment according to the third embodiment of the present invention;

FIG. 11 is a schematic diagram of the configuration of an optical axis adjustment device according to a fourth embodiment of the present invention;

FIG. 12 is an explanatory diagram for an example of control of the optical axis adjustment device by a controller in the fourth embodiment of the present invention;

FIG. 13 illustrates examples of beam scanning loci in the fourth embodiment of the present invention; and

FIG. 14 illustrates other examples of beam scanning loci in the fourth embodiment of the present invention.

### DESCRIPTION OF THE EMBODIMENTS

### First Embodiment

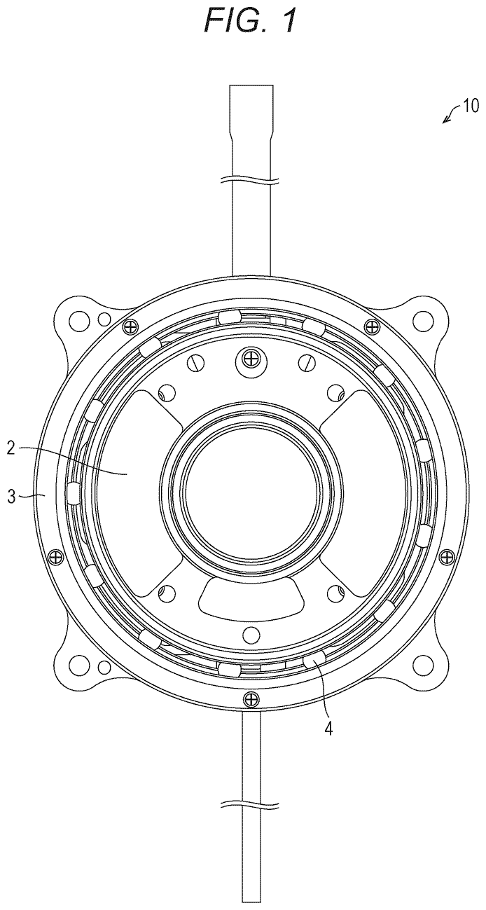

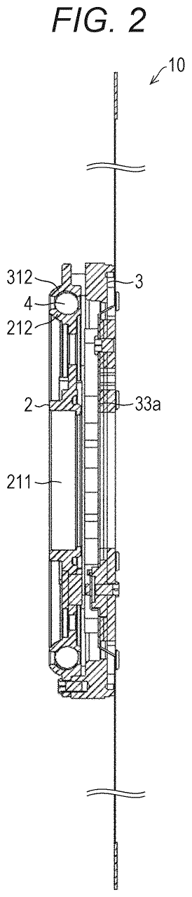

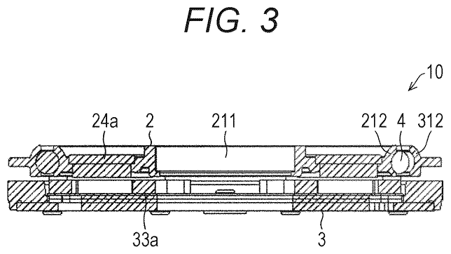

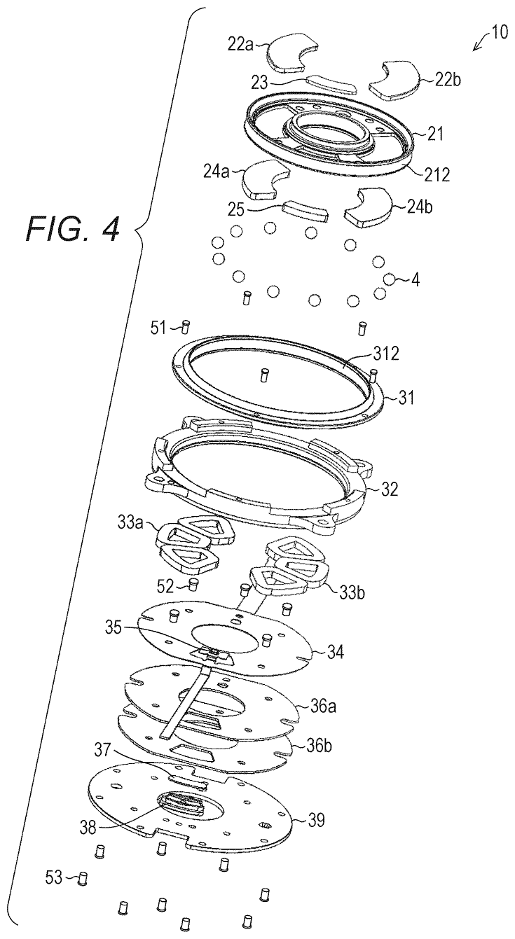

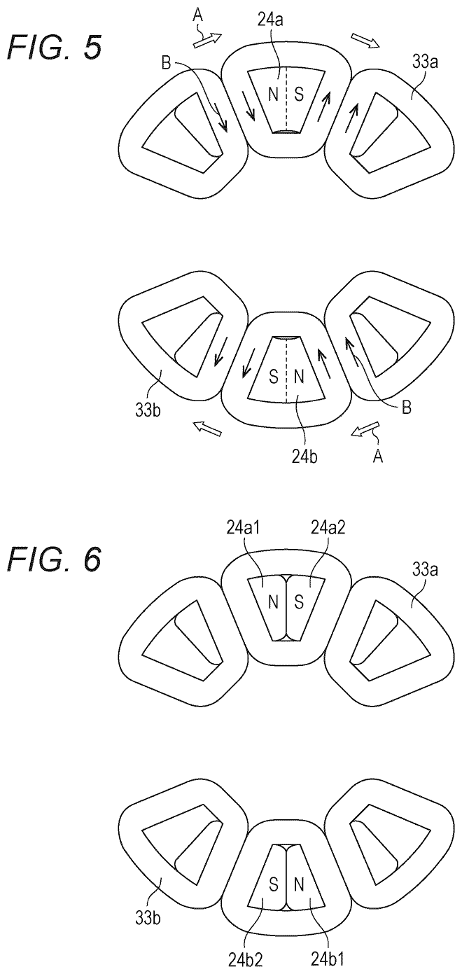

An actuator for optical axis adjustment according to an embodiment of the present invention will be described below. FIG. 1 is a plan view schematically illustrating an actuator for optical axis adjustment according to the present embodiment. FIG. 2 is a sectional view schematically illustrating a longitudinal section of the actuator for optical axis adjustment according to the present embodiment, and FIG. 3 is a sectional view schematically illustrating a cross section of the actuator for optical axis adjustment according to the present embodiment. Furthermore, FIG. 4 is an exploded perspective view schematically illustrating the configuration of the actuator for optical axis adjustment according to the present embodiment. Note that FIG. 5 is a schematic view of a first example of arrangement of magnets for driving and coils in the present embodiment, and FIG. 6 is a schematic view of a second example of arrangement of magnets for driving and coils in the present embodiment.

As illustrated in FIGS. 1 to 4, an actuator for optical axis adjustment 10 includes a movable unit 2 and a fixed unit 3 combined through rolling members 4. Note that the actuator for optical axis adjustment 10 is made of proper materials, and examples of the materials include a resin subjected to surface finishing, a resin not subjected to surface finishing, a resin composite containing a filler such as glass fiber, metals such as aluminum, stainless steel, a galvanized steel sheet, and a non-oriented magnetic steel sheet, magnets such as NdFeB, and magnet wires.

The movable unit 2 serves as a member that is capable of holding a wedge prism (not illustrated) as an exemplary anisotropic optical element and is rotatable around the optical axis of the held optical element. The movable unit 2 includes a rotor 21, driving magnet yokes 22a and 22b, a sensor magnet yoke 23, driving magnets 24a and 24b, and a sensor magnet 25. The rotor 21 is a substantially annular and plate-shaped member and has a circular opening at its center as a wedge prism fixer 211, and thus a wedge prism as a type of anisotropic optical element can be fitted to the opening.

The fixed unit 3 serves as a member that holds the movable unit 2 rotatably. The fixed unit 3 includes an outer stator 31, a rotor spacer 32, coils 33a and 33b, a flexible printed circuit (FPC) 34, a Hall element 35, driving magnet back yokes 36a and 36b, a sensor magnet back yoke 37, a sensor height adjuster 38, and a main plate 39.

The driving magnet back yokes 36a and 36b are disposed facing the driving magnets 24a and 24b axially.

The sensor magnet yoke 23, the sensor magnet 25, the sensor magnet back yoke 37, and the Hall element 35 are constituents of a sensor that detects the position in the rotational direction of the movable unit 2

The sensor magnet 25 corresponds to a magnetic-field generator for detection disposed along the rotational direction in the movable unit 2, and the Hall element 35 is disposed along the rotational direction in the fixed unit 3 and overlaps the sensor magnet 25 axially.

In the movable unit 2, the driving magnets 24a and 24b are fitted one-to-one into holes provided to the rotor 21, and the driving magnet yokes 22a and 22b are fixed thereto, respectively. The driving magnet yokes 22a and 22b are disposed, respectively, facing the driving magnets 24a and 24b having their polarization directions identical to an optical axis direction.

In the fixed unit 3, the coils 33a and 33b are fixed onto the FPC 34. The coils 33a and 33b each include three coils disposed adjacently. The coils are each a coreless coil. Note that the wiring of the FPC 34 is connected to each coil such that the amount of electric current in each coil and the direction of electric current in each coil are adjustable as appropriate. In the actuator for optical axis adjustment 10, the driving magnets 24a and 24b and the coils 33a and 33b are constituents of a voice coil motor.

A single driving magnet 24a is disposed for the coil 33a, and a single driving magnet 24b is disposed for the coil 33b. The driving magnets 24a and 24b each have two regions different in polarization direction. As illustrated in FIG. 5, the driving magnets 24a and 24b each form a magnetic field such that a reverse is made in polarization direction at a particular position (at the center in its circumferential direction to the central coil among the three coils in the present embodiment). Thus, in the present embodiment, the area at which a reverse is made in polarization direction may be the boundary between the north (N) and south(S) poles of a single magnet as illustrated in FIG. 5, or the abutment between the respective north (N) and south(S) poles of different driving magnets 24al and 24a2 or driving magnets 24b1 and 24b2 as illustrated in FIG. 6.

The driving magnets 24a and 24b and the coils 33a and 33b are each arc-shaped in plan view and suitable in shape to any substantially annular part in the actuator for optical axis adjustment 10. Referring to FIG. 5, the direction of electric current flowing in each coil in a region of interlinkage flux is indicated with an arrow or arrows B and the direction of thrust generated due to such electric current is indicated with arrows A almost along the circumferential direction of the movable unit 2. Thus, the driving magnets 24a and 24b are constituents of a magnetic-field generator for driving disposed along the rotational direction of the movable unit 2 in the movable unit 2, and the coils 33a and 33b are disposed along the rotational direction in the fixed unit 3 and overlap the magnetic-field generator for driving.

A movable-unit groove 212 is formed all over the outer circumferential edge of the rotor 21, and a fixed-unit groove 312 is provided all over the inner circumferential edge of the outer stator 31. The movable-unit groove 212 and the fixed-unit groove 312 each have an arc-shaped cross section. Thus, the movable-unit groove 212 corresponds to a first groove formed circumferentially on the movable unit 2 with respect to the rotational direction of the movable unit 2, and the fixed-unit groove 312 corresponds to a second groove that is formed circumferentially with respect to the rotational direction and faces the first groove radially.

The movable-unit groove 212 and the fixed-unit groove 312 face mutually radially such that the rolling members 4 are sandwiched as a plurality of spheres between the movable-unit groove 212 and the fixed-unit groove 312. Thus, each rolling member 4 is sandwiched between the movable-unit groove 212 and the fixed-unit groove 312 that face radially with respect to the rotational direction, and the movable-unit groove 212, the fixed-unit groove 312, and the rolling members 4 form a bearing structure. Note that the inner circumferential wall face of the cross section of each of the movable-unit groove 212 and the fixed-unit groove 312 is substantially arc-shaped and the shape of the inner circumferential wall face is slightly larger in the radius of curvature than each rolling member 4.

Furthermore, the outer stator 31 is fastened to the rotor spacer 32 through screws 51. The FPC 34 and the driving magnet back yokes 36a and 36b are fastened to the main plate 39 through screws 52. The main plate 39 is fastened to the rotor spacer 32 through screws 53.

The distance between each of the Hall element 35, the sensor magnet back yoke 37, and the sensor magnet 25 is adjusted as appropriate by the sensor height adjuster 38.

### [Major Operation and Advantageous Effects]

The driving magnet back yokes 36a and 36b are disposed facing the driving magnets 24a and 24b having their polarization directions identical to the optical axis direction (out of illustration). Thus, attractive force is generated in the optical axis direction, so that the movable unit 2 is attracted to the fixed unit 3. Such axial urging inhibits play in the axial direction of the movable unit 2.

As described above, the shape of the cross section of each of the movable-unit groove 212 and the fixed-unit groove 312 is slightly larger in the radius of curvature than each rolling member 4. Therefore, even in a case where the movable unit 2 and the fixed unit 3 have errors (tolerances) due to the shapes of the grooves, the sizes of the rolling members 4, or the assembly of the movable unit 2 and the fixed unit 3 and then a shift is made in the position of the movable unit 2 to the fixed unit 3, the positional relationship between the movable unit 2 and the fixed unit 3 is retained such that one of the movable-unit groove 212 and the fixed-unit groove 312 is slightly shifted in position to the other with the rolling members 4 sandwiched. Thus, even in a case where the actuator for optical axis adjustment 10 has tolerances, the movable unit 2 is prevented from being at an angle to the fixed unit 3 because the entirety of the movable unit 2 moves axially with respect to the fixed unit 3 such that the tolerances are absorbed. Therefore, inhibited can be backlash due to the movable-unit groove 212, the fixed-unit groove 312, and the rolling members 4. Thus, the movable unit 2 is prevented from being brought into play in the optical axis direction in a case where a force in optical axis direction that is caused by a change in pose due to the precision of assembly or components or backlash due to the rolling members and the grooves is larger than the force holding the movable unit 2.

Thus, the actuator for optical axis adjustment 10 enables holding without backlash due to the rolling members 4 and the respective grooves 212 and 312 provided to the movable unit 2 and the fixed unit 3, leading to inhibition of play in the optical axis direction at the time of rotational movement. Thus, the actuator for optical axis adjustment 10 that moves a wedge prism rotationally enables inhibition of play in the optical axis direction even at the time of rotational movement in a high-rate range and thus enables the movable unit 2 to move rotationally at a high rate.

The voice coil motor formed in the present embodiment is a single-phase coreless motor and thus the thrust ripple due to commutation or cogging is small, leading to sensitive smooth control. Therefore, micro-vibrations are inhibited from occurring in rotation. Accordingly, from the viewpoint of stable laser directivity, use of the voice coil motor in optical wireless communication is advantageous.

The voice coil motor is small in coil inductance, and the movable unit 2 is light in weight. Thus, a high-frequency operation is allowed with high operational responsivity.

The movable unit 2 is supported to the fixed unit 3 due to the bearing structure and thus the movable unit 2 is generally light in weight. Therefore, a reduction is made in consumption current required for driving, leading to facilitation of miniaturization of a controller.

The voice coil motor generates thrust proportional to an electric current flowing due to the influence of a magnetic field. Thus, precise load control can be performed. The movable unit 2 is directly controlled by thrust generated due to coil energization. Thus, the voice coil motor is advantageous to precise rotation.

Furthermore, the voice coil motor has a thin structure because the coils are disposed to surround the outer circumference of an anisotropic optical element.

Furthermore, in the actuator for optical axis adjustment 10, the distance between each of the Hall element 35, the sensor magnet back yoke 37, and the sensor magnet 25 is adjusted by the sensor height adjuster 38. A detectable magnetic-flux density distribution varies depending on distance, and thus the above-described configuration is favorable from the viewpoint of adjustment to a distance at which a desired magnetic-flux density distribution can be detected.

Other embodiments of the present invention will be described below. Note that, in description of the following other embodiments, for convenience of description, members identical in function to the members described in the above-described embodiment are denoted with the same reference signs and thus duplicate descriptions thereof will be omitted.

### Second Embodiment

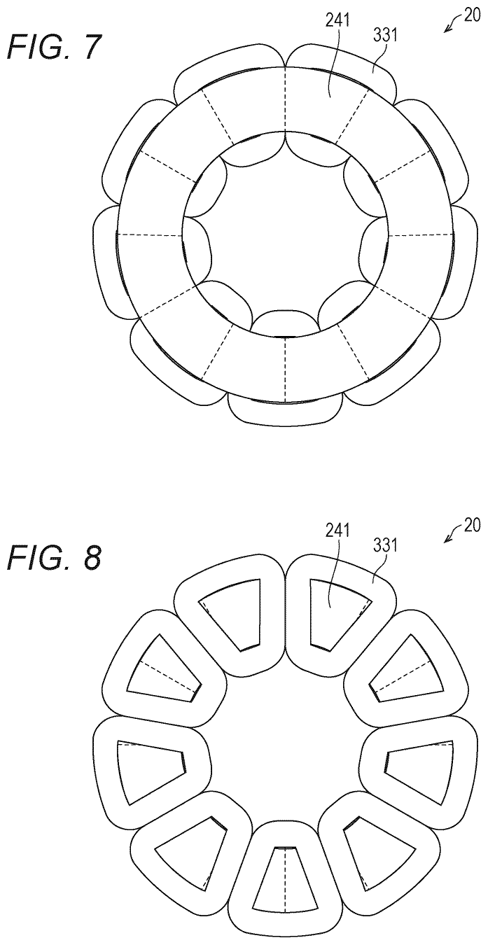

Features of an actuator for optical axis adjustment according to the present embodiment are schematically illustrated in FIGS. 7 and 8. The actuator for optical axis adjustment according to the present embodiment is similar in configuration to the actuator for optical axis adjustment 10 according to the first embodiment described above except that a magnet for driving and coils are disposed over the entire circumference but no magnet for position detection, Hall element, yoke, and back yoke are included.

As illustrated in FIGS. 7 and 8, an actuator for optical axis adjustment 20 includes a movable unit and a fixed unit. The movable unit includes a rotor, a driving magnet yoke, and a driving magnet 241. The driving magnet 241 is disposed all over the circumference of an opening at the center of the rotor outside the opening. The driving magnet 241 has 12 sections and forms a magnetic field with any adjacent two sections different in magnet pole (e.g., N and S alternations). Broken lines in the drawings each indicate the boundary between magnetic poles. The driving magnet yoke, which is not illustrated, is disposed on a main face opposite to the driving magnet 241 with respect to the rotor over the entire circumference correspondingly to the driving magnet 241.

The fixed unit includes an outer stator, a rotor spacer, coils 331, an FPC, a driving magnet back yoke, and a main plate. The coils 331 are each a coreless coil substantially trapezoidal like a sector in plan view similarly to the first embodiment. As the coils 331, nine coreless coils are disposed side by side circumferentially. The driving magnet back yoke is disposed, over the entire circumference, correspondingly to the driving magnet 241.

In the actuator for optical axis adjustment 20, an electric current properly directed in accordance with the magnetic pole of the driving magnet 241 is supplied from the FPC to each coil 331, so that the movable unit drives rotationally in a desired direction. The direction of supply current is switched as appropriate, enabling continuously rotational driving of the movable unit in one direction. The rotational rate of the movable unit can be controlled based on the amount of supply current. The position of the movable unit to the fixed unit in the rotational direction can be controlled, for example, by acquiring information on the rotational amount, rotational rate, or rotational direction of the movable unit by an encoder in combination with the actuator for optical axis adjustment 20.

Note that, according to the second embodiment, a wedge prism can be prevented from being brought into play at the time of rotation, similarly to the first embodiment.

### Third Embodiment

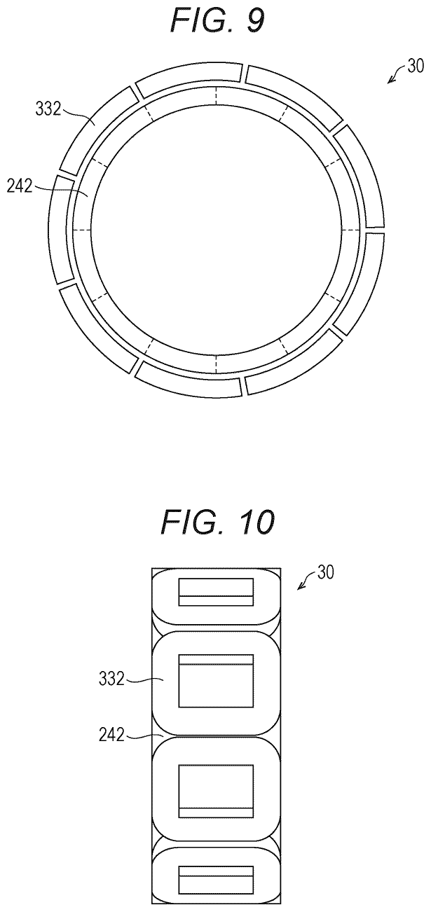

Features of an actuator for optical axis adjustment according to the present embodiment are schematically illustrated in FIGS. 9 and 10. The actuator for optical axis adjustment according to the present embodiment is similar in configuration to the actuator for optical axis adjustment 20 according to the second embodiment described above except that a magnet for driving and coils are disposed facing radially and a constituent that urges a movable unit is further provided.

An actuator for optical axis adjustment 30 includes a movable unit and a fixed unit. In the present embodiment, the movable unit and the fixed unit are each formed with a cylinder, and the actuator for optical axis adjustment 30 has a double-cylinder structure of such cylinders and can be formed, for example, with an inner cylinder as the movable unit and an outer cylinder as the fixed unit.

As illustrated in FIGS. 9 and 10, in the actuator for optical axis adjustment 30, a driving magnet 242 having 12 sections is disposed all over the outer circumferential face of the inner cylinder, and nine coils 332 are disposed all over the inner circumferential face of the outer cylinder. The circumferential correspondence between the driving magnet 242 and the coils 332 is similar to that in the second embodiment described above. The configuration of the inner cylinder is similar to that of the movable unit in the second embodiment, and the configuration of the outer cylinder is similar to that of the fixed unit in the second embodiment.

In the inner cylinder, an anisotropic optical element, such as a wedge prism, is disposed at the center inside the driving magnet 242. The central axis (rotational axis) of the inner cylinder is identical to the optical axis of the optical element. For example, the inner cylinder has a substantially semicircular movable-unit groove as a recess formed radially outside its end portion and the outer cylinder has a substantially semicircular fixed-unit groove as a recess formed radially inside its end portion. Three or more spherical rolling members are sandwiched by the radially facing movable-unit groove and fixed-unit groove.

Note that the actuator for optical axis adjustment 30 further includes an urging member that urges the inner cylinder axially. The urging member is, for example, an elastic member such as a spring. The urging member urges the inner cylinder to the fixed unit axially with a force corresponding to the magnetic force by which the movable unit and the fixed unit are attracted together in the first and second embodiments (e.g., the magnetic force between a magnet and a back yoke). The urging member urges only the inner cylinder to the axially fixed outer cylinder axially. In contrast, in a case where the inner cylinder is fixed axially, the urging member may urge the outer cylinder to the inner cylinder axially. In a case where the inner cylinder and the outer cylinder are axially movable, the urging member may urge the inner cylinder and the outer cylinder such that a force to both the cylinders corresponds to the above-described magnetic force.

The actuator for optical axis adjustment 30 is similar in effect to the actuator for optical axis adjustment 20. Furthermore, the actuator for optical axis adjustment 30 is smaller in the moment of inertia than the actuator for optical axis adjustment 20 and thus is advantageous from the viewpoint of high-rate rotation of the movable unit.

### Fourth Embodiment

The present embodiment is an embodiment in which such actuators for optical axis adjustment as described above are applied to an optical wireless communication apparatus.

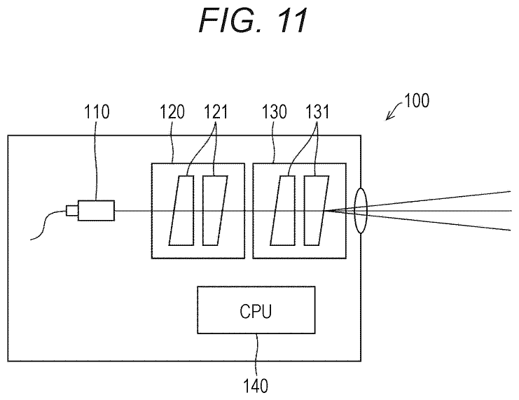

As illustrated in FIG. 11, an optical wireless communication apparatus 100 includes an optical beam emitter 110, a communication optical system 120, a beacon optical system 130, and a central processing unit (CPU) 140.

The optical beam emitter 110 outputs an optical beam to be emitted from the optical wireless communication apparatus 100. The optical beam is, for example, signal light in optical wireless communication or beacon light for identifying a communication partner. The optical beam emitter 110 may be, for example, a connector at the end of the optical path of an optical beam or a group of various types of devices for generating signal light or beacon light.

The communication optical system 120 includes two first optical axis adjustment devices 121. The first optical axis adjustment devices 121 each include the actuator for optical axis adjustment 10 in the first embodiment on which a wedge prism is mounted.

The beacon optical system 130 includes two second optical axis adjustment devices 131. The second optical axis adjustment devices 131 each include the actuator for optical axis adjustment 20 in the second embodiment on which a wedge prism is mounted. The second optical axis adjustment devices 131 each further include an encoder for detecting the rotational driving of the wedge prism. A signal output from the encoder, which is connected to the CPU 140, in each second optical axis adjustment device 131 is transmitted to the CPU 140.

The CPU 140 controls the operations of the optical beam emitter 110, the communication optical system 120, and the beacon optical system 130.

The optical wireless communication apparatus 100 includes, as appropriate, an optical system for the optical path of an optical beam output from the optical beam emitter 110 other than the above-described constituents. Such optical systems can be formed as appropriate using publicly known optical elements on the basis of publicly known techniques in optical wireless communication.

For optical wireless communication, the optical wireless communication apparatus 100 drives the beacon optical system 130 to capture a communication partner and then drives the communication optical system 120 to perform optical wireless communication. For capturing the communication partner, the optical beam emitter 110 outputs beacon light and then, for example, a beam divergence control element, not illustrated, in the beacon optical system 130 generates a diffused beam using the beacon light. The CPU 140 causes the diffused beam to be output on the basis of information on the estimated position on the trajectory of the communication partner. Then, the respective movable units of the two second optical axis adjustment devices 131 are rotationally driven to perform scanning with the diffused beam.

The optical wireless communication apparatus 100 decreases the beam diameter of the diffused beam such that the communication partner found in a process of scanning is included in the front scanning region and then reduces the region of scanning while capturing the communication partner. Then, finally, the beam diameter of the beacon light is reduced to obtain collimated light of which the beam diameter is constant.

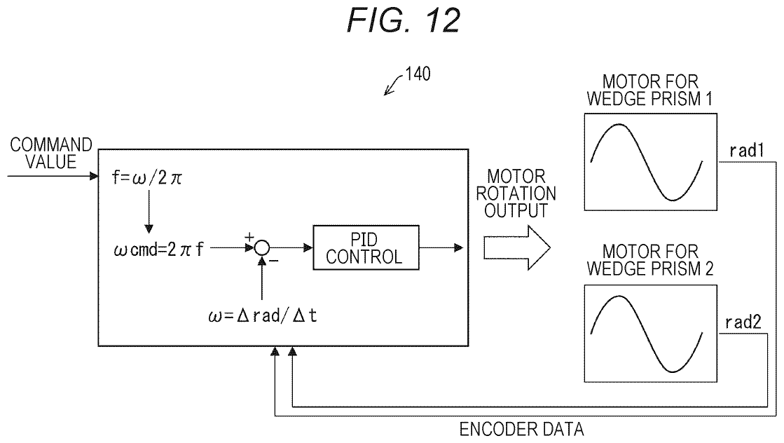

Next, an aspect of control of an optical axis adjustment device by the CPU 140 will be described. As illustrated in FIG. 12, the CPU 140 acquires the rotational frequency of the wedge prism of each optical axis adjustment device, as a command value, from an external device or an input device, such as an internal memory. Then, the CPU 140 converts, for example, each command value for frequency setting into the corresponding frequency.

Next, the CPU 140 acquires, from each optical axis adjustment device, as a current value, an output signal of the rotational position and rotational motion of the wedge prism.

Next, the CPU 140 performs feedback control to cancel the difference between the command value and the current value. For example, the CPU 140 acquires data from the encoder in the actuator for optical axis adjustment for the wedge prism of each optical axis adjustment device and divides a variation by a defined interval Δt. Then, the CPU 140 performs feedback control on the basis of the fed-back angular velocity as the current value and the angular velocity at the target frequency.

Next, the CPU 140 outputs a signal of information on supply current to the coils of the actuator for optical axis adjustment in each optical axis adjustment device (motor rotation output), as a control value, to a power source for the coils. As above, the CPU 140 manages the rotational frequency and operation time of the wedge prism in each optical axis adjustment device.

The command value, for example, in scanning with the beacon light for capturing the communication partner is determined as follows. First, a relationship is established between the projected coordinates on a front XY plane of transmitted light through the wedge prism of each of two second optical axis adjustment devices 131, the rotational frequency of each wedge prism, and the rotational time of each wedge prism. Next, on the basis of geometrical optics, the XY-plane projected coordinates, angle on an XZ plane, and angle on a YZ plane of the transmitted light at the rotational position of each wedge prism are each calculated. Next, on the basis of a result from the calculation, the locus of the beacon light is analyzed.

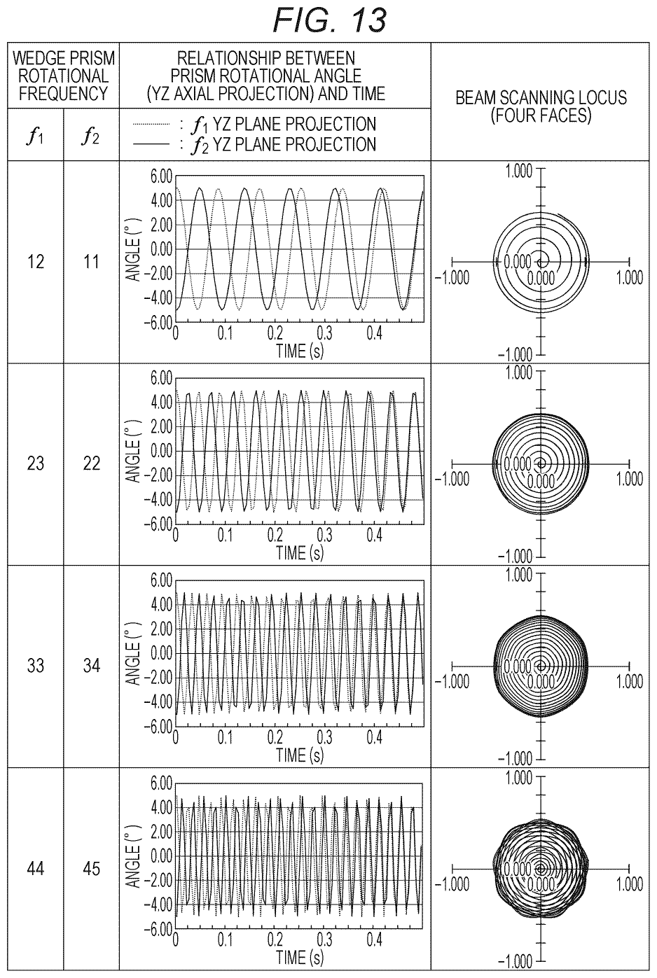

As an example of the analysis, FIG. 13 illustrates exemplary conditions of the beacon light having a spiral locus on the XY plane (front). In the drawing, rotational frequency f₁ indicates the rotational frequency of the wedge prism on the light source side (closer to the optical beam emitter 110) in the beacon optical system 130, and rotational frequency f₂ indicates the rotational frequency of the wedge prism on the communication partner side in the beacon optical system 130. A dotted line in the drawing indicates the relationship between the rotational angle of the wedge prism on the light source side and time, and a solid line in the drawing indicates the relationship between the rotational angle of the wedge prism on the communication partner side and time. As illustrated in FIG. 13, a rise in the rotational frequency of each of the wedge prisms in the beacon optical system 130 enables a denser spiral locus.

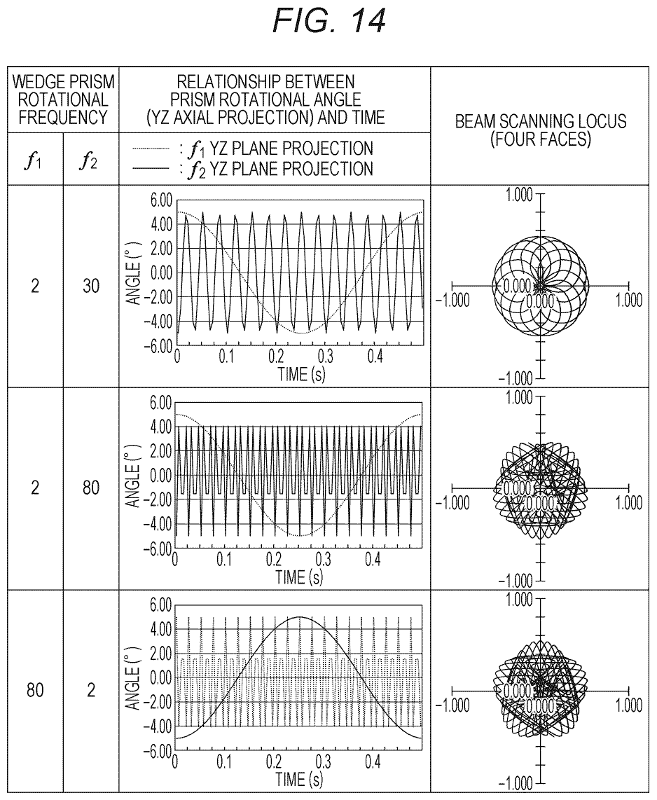

As an example of the analysis, FIG. 14 illustrates an exemplary condition of the beacon light having a locus varying in shape on the XY plane (front). As illustrated, proper control of the rotational motion of each of the two wedge prisms in the beacon optical system 130 adjusts the optical axis of the beacon light such that the beacon light has a dense locus varying in shape on the front.

When the communication partner is captured, the CPU 140 performs optical wireless communication with the captured communication partner. In the optical wireless communication, the optical beam emitter 110 outputs signal light for communication, and the CPU 140 acquires positional information on the signal light received by a beam splitter and a photodetector, not illustrated, and then rotates, on the basis of the positional information, the actuator for optical axis adjustment of each first optical axis adjustment device 121 in the communication optical system 120 at a proper rate and a proper angle to fine-adjust the optical axis of the signal light being output. Thus, inhibited is influence from external disturbance, such as weather disorder or space propagation disturbance, in the optical wireless communication, leading to achievement of reliable optical wireless communication.

In the present embodiment, any of the optical axis adjustment devices is a so-called transmissive optical axis adjustment device that rotates an anisotropic optical element to adjust an optical axis. Therefore, optical connection between the optical beam emitter and the corresponding optical axis adjustment device or optical connection between each of the optical axis adjustment devices can be sufficiently achieved using a general-purpose optical member, such as a connector.

Such a transmissive optical axis adjustment device requires an anisotropic optical element having an aperture larger than the beam diameter of the optical beam and thus has a configuration similar to the configuration of a device that is independent of the diameter of an optical beam and is high in versatility.

In the present embodiment, the communication optical system 120 and the beacon optical system 130 each include a pair of wedge prisms and one of the above-described actuators for optical axis adjustment for each wedge prism. For each optical system, further axial addition of a set of a wedge prism and an actuator for optical axis adjustment can be easily achieved.

Furthermore, in each of the optical axis adjustment devices in the present embodiment, the wedge prism (movable unit) can be directly rotationally driven by the voice coil motor with a degree of precision higher than the resolution of each of the above-described encoders that detect a rotation of 360°. Therefore, in the beacon optical system 130, rotational driving of the wedge prisms can be achieved with no deterioration in the accuracy of detection of the rotational position of each wedge prism.

### OTHER EMBODIMENTS

In an embodiment of the present invention, any anisotropic optical element other than wedge prisms can be applied. Examples of anisotropic optical elements include metalenses and polarization elements in addition to wedge prisms.

In an embodiment of the present invention, a movable-unit groove may be radially outside a fixed-unit groove, that is, the fixed-unit groove may be radially inside the movable-unit groove. Provided that an effect of the present invention (namely, an effect of preventing play by axial displacement of the entire movable unit due to rotational driving) is achieved, the movable-unit groove and the fixed-unit groove are not necessarily formed over the entire circumference of the movable unit or may each include a plurality of grooves.

### SUMMARY

According to a first aspect of the present invention, provided is an actuator for optical axis adjustment (10) including: a fixed unit (3); a movable unit (2) configured to hold an anisotropic optical element (wedge prism), the movable unit being attached rotatably to the fixed unit; a magnetic-field generator for driving disposed along a rotational direction of the movable unit in one of the movable unit and the fixed unit; a coil (33a, 33b) disposed along the rotational direction in another of the movable unit and the fixed unit, the coil overlapping the magnetic-field generator for driving; a first groove (movable-unit groove 212) formed circumferentially on the movable unit with respect to the rotational direction; a second groove (fixed-unit groove 312) formed circumferentially on the fixed unit with respect to the rotational direction; and three or more rolling members (4) sandwiched between the first groove and the second groove, in which the first groove and the second groove face mutually radially with respect to the rotational direction. According to the first aspect, achieved can be an actuator for an optical axis adjustment device that inhibits play of the optical axis of an anisotropic optical element even at the time of high-rate rotation.

According to a second aspect of the present invention, in the first aspect, the first groove is formed all over an outer circumference of the movable unit, and the second groove is formed all over an inner circumference of the fixed unit, the inner circumference facing the outer circumference. From the viewpoint of easy achievement of a bearing structure, the second aspect is much more effective.

According to a third aspect of the present invention, in the first or second aspect, the coil is a coreless coil. From the viewpoint of inhibition of occurrence of cogging in rotation of the movable unit, the third aspect is much more effective.

According to a fourth aspect of the present invention, in any of the first to third aspects, the magnetic-field generator for driving includes a plurality of magnets (24a1, 24a2) disposed reversely in polarization direction. According to the fourth aspect, the number of magnets can be freely set, and the number of coils is determined depending on the number of magnets, followed by adjustment of the rotational rate of the movable unit. For example, an increase in the number of magnets causes an increase in the number of coils, leading to an increase in the thrust for rotation of the movable unit, so that the movable unit can be rotated at a higher rate. From the viewpoint of control of the rotational rate of the movable unit, the fourth aspect is much more effective. For example, from the viewpoint of generation of thrust against the movable unit for precise control of rotation of the movable unit, the fourth aspect is much more effective.

According to a fifth aspect of the present invention, the actuator for optical axis adjustment in any of the first to fourth aspects further includes a back yoke for driving (driving magnet back yokes 36a, 36b) disposed along the rotational direction in the another of the movable unit and the fixed unit, the back yoke for driving overlapping the magnetic-field generator for driving. From the viewpoint of prevention of play at the time of rotation of the movable unit, the fifth aspect is much more effective.

According to a sixth aspect of the present invention, the actuator for optical axis adjustment in any of the first to fifth aspects further includes a sensor configured to detect a position in the rotational direction of the movable unit. From the viewpoint of detection of the rotational position of the movable unit (anisotropic optical element), the sixth aspect is much more effective.

According to a seventh aspect of the present invention, in the sixth aspect, the sensor includes: a magnetic-field generator for detection disposed along the rotational direction in the one of the movable unit and the fixed unit; and a Hall element (35) disposed along the rotational direction in the another of the movable unit and the fixed unit, the Hall element overlapping the magnetic-field generator for detection. From the viewpoint of simple and precise detection of the rotational position of the movable unit (anisotropic optical element), the seventh aspect is much more effective.

According to an eighth aspect of the present invention, an optical axis adjustment device includes: the actuator for optical axis adjustment according to any of the first to seventh aspects; and an anisotropic optical element held by the movable unit. According to the eighth aspect, achieved can be an optical axis adjustment device that inhibits play of the optical axis of an anisotropic optical element even at the time of high-rate rotation.

According to a ninth aspect of the present invention, in the eighth aspect, the anisotropic optical element is a wedge prism. From the viewpoint of a high level of versatility enabling prevention of an optical beam from vibrating or scanning with an optical beam, the ninth aspect is much more effective.

The present invention is not limited to the above-described embodiments, and thus various modifications can be made within the scope of the claims. Embodiments obtained by combining as appropriate the respective technical means disclosed in different embodiments are to be included in the technical scope of the present invention.

According to the above-described embodiments of the present invention, even in a case where an anisotropic optical element is rotated at a high rate, the rotating optical element is inhibited from being brought in play. Thus, for example, application of the present invention to optical wireless communication requiring high-rate rotation of an anisotropic optical element enables enhancements in the stability and reliability of the optical wireless communication. The present invention having such effects is expected to bring revolutionary progress and development for optical wireless communication technology and contributes, for example, to achievement of Goal 9 “Build resilient infrastructure, promote sustainable industrialization and foster innovation” in the United Nations' sustainable development goal (SDGs).

What is claimed is:

1. An actuator for optical axis adjustment, comprising:
a fixed unit;
a movable unit configured to hold an anisotropic optical element, the movable unit being attached rotatably to the fixed unit;
a magnetic-field generator for driving disposed along a rotational direction of the movable unit in one of the movable unit and the fixed unit;
a coil disposed along the rotational direction in another of the movable unit and the fixed unit, the coil overlapping the magnetic-field generator for driving;
a first groove formed circumferentially on the movable unit with respect to the rotational direction;
a second groove formed circumferentially on the fixed unit with respect to the rotational direction; and
three or more rolling members sandwiched between the first groove and the second groove, wherein
the first groove and the second groove face mutually radially with respect to the rotational direction.

2. The actuator for optical axis adjustment according to claim 1, wherein the first groove is formed all over an outer circumference of the movable unit, and
the second groove is formed all over an inner circumference of the fixed unit, the inner circumference facing the outer circumference.

3. The actuator for optical axis adjustment according to claim 1, wherein the coil is a coreless coil.

4. The actuator for optical axis adjustment according to claim 1, wherein the magnetic-field generator for driving includes a plurality of magnets disposed reversely in polarization direction.

5. The actuator for optical axis adjustment according to claim 1, further comprising a back yoke for driving disposed along the rotational direction in the another of the movable unit and the fixed unit, the back yoke for driving overlapping the magnetic-field generator for driving.

6. The actuator for optical axis adjustment according to claim 1, further comprising a sensor configured to detect a position in the rotational direction of the movable unit.

7. The actuator for optical axis adjustment according to claim 6, wherein
the sensor includes:
a magnetic-field generator for detection disposed along a rotational direction in the one of the movable unit and the fixed unit; and
a Hall element disposed along the rotational direction in the another of the movable unit and the fixed unit, the Hall element overlapping the magnetic-field generator for detection.

8. An optical axis adjustment device comprising:
the actuator for optical axis adjustment according to claim 1; and
an anisotropic optical element held by the movable unit.

9. The optical axis adjustment device according to claim 8, wherein the anisotropic optical element is a wedge prism.
